(19) United States
(12) Patent Application Publication
(10) Pub. No.: US 2024/0023632 A1
(43) Pub. Date: Jan. 25, 2024

(54) ELECTRONIC VAPORIZER FOR SOLID MATERIALS WITH MULTIPLE-TEMPERATURE HEATING SYSTEM

(71) Applicant: EVOLV, LLC, Hudson, OH (US)

(72) Inventor: John Bellinger Decker, Wexford, PA (US)

(21) Appl. No.: 18/226,040

(22) Filed: Jul. 25, 2023

Related U.S. Application Data
(60) Provisional application No. 63/392,038, filed on Jul. 25, 2022.

(51) Int. Cl. A24F 40/57; A24F 40/20; A24F 40/42; A24F 40/46; A24F 40/60; A24F 40/51; H05B 3/06

(52) U.S. Cl. CPC A24F 40/57; A24F 40/20; A24F 40/42; A24F 40/46; A24F 40/60; A24F 40/51; H05B 3/06

(57) ABSTRACT

An electronic vaporizer for solid and semi-solid materials which includes a controller, and a heating chamber whose walls are constructed from an electrically resistive material to perform both structural and heating functions. The controller is electrically connected to and supplies power to the heating chamber. The controller contains both a melting and an aerosolizing temperature setpoint according to the material loaded, and automatically sequences from one to the other after an appropriate delay. The vaporizer contains a sensor which detects the opening of the chamber and communicates this state to the controller, which pre-melts the material to the chamber during or after material loading.

### CROSS-REFERENCE TO RELATED APPLICATIONS

This application claims the benefit of U.S. Provisional Patent Application No. 63/392,038, filed Jul. 25, 2022, the entire contents of which are incorporated herein by reference.

### FIELD

The subject matter described herein relates to vaporizer devices for aerosolizing solid or semi-solid materials.

### BACKGROUND

Electronic vaporizers are devices used to generate an aerosol of a material to be consumed by the user. They work by heating the substance to be consumed above the boiling point of the material to generate a vapor, and then entraining that vapor into an airstream generated by the user's inhalation, resulting in the vapor re-condensing into an aerosol. These devices are used from time to time during the day by the user. Some vaporizers use a tank of liquid material, and other vaporizers use a chamber which is manually loaded before operation with a solid, wax or semi-solid material. A significant problem with existing electronic personal vaporizers which use a manually user-loaded material in a chamber is that it takes significant time (15 seconds to 2 minutes is typical) to reach operating temperature. Vaporizers of this type use a ceramic or glass cup, which is indirectly heated by a wound coil or other resistive or inductive heating element affixed mechanically to the bottom and/or outside walls of the chamber. These glass or ceramic cups are necessarily thick, on the order of 1-2 millimeters, because they need to survive thermal stresses, handling by the user as well as the bumps and shocks typical to personal electronics. The thickness of these chamber walls is also necessary to evenly distribute the heat from the heater geometry to the material. An example of this type of atomizer can be found in U.S. Pat. No. 11,064,738, which describes “A heating crucible thermally coupled to the base element.”

### SUMMARY

The following presents a simplified summary of the disclosure to provide a basic understanding of some aspects described in the detailed description.

According to one aspect of the present invention, a chamber for heating the material to be atomized is constructed from a thin metal foil which is heated resistively directly, reducing the total thermal mass of the chamber compared to existing indirectly heated designs.

According to another aspect of the present invention, this reduction in thermal mass of the chamber allows for significantly increased maximum heating rate of the chamber, which is beneficial to the user experience but can allow material to be atomized which is in contact with the integrally heated walls to melt and then vaporize before the material farthest from the integrally heated walls can melt, thereby propelling chunks of material into the airstream. To counteract this, a controller that rapidly increases the temperature of the material to a setpoint above the melting point of the material, but below the boiling point of the material is provided. This controller then maintains the chamber temperature at this first setpoint for a preset time before automatically transitioning to a second setpoint above the boiling point of the material, which generates aerosol.

Another aspect of the present invention includes a sensor in communication with the controller, which detects when the user opens the heating chamber to load new material. While or after the user is loading material as sensed by this sensor, the controller maintains the chamber at a temperature above the melting point and below the boiling point of the material to be atomized, to increase the surface area of material in contact with the integral heating element of the chamber. This reduces the time required to melt the material before vaporization can occur without chunking.

Another aspect of the present invention is that the setpoints and delays can be adjusted by the user to accommodate a variety of materials to be aerosolized having different properties.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 is an integrally heated material chamber;

FIG. 2 is a two stage temperature control chamber temperature graph;

FIG. 3 is a vaporizer system with cap detecting sensor;

FIG. 4 is a pre-melt process flow chart; and

FIG. 5 is two-stage heating process flow chart.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

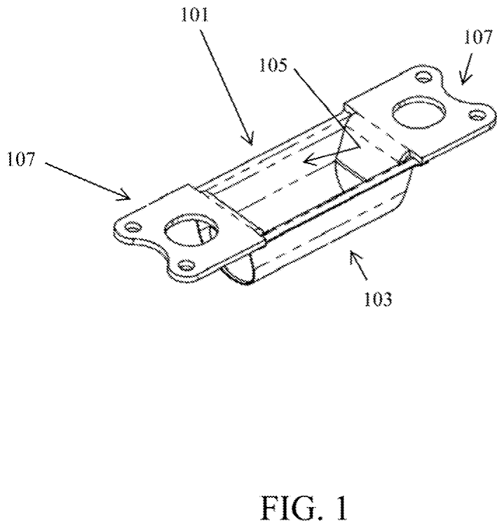

FIG. 1 illustrates a heating chamber 101 in accordance with an embodiment of the disclosure. An integral heating section 103 can be constructed from a thin conductive material which may be heated resistively. That is, the thin conductive material of the integral heating section 103 serves both as a chamber surface 105 to contain the material as well as a heating element to melt or aerosolize it. Using the thin conductive material to contain as well as heat the material removes the thermal mass associated with the ceramic or glass chamber, as well as the poor thermal transfer associated with indirectly heating the glass chamber. In a preferred embodiment, this thin conductive material is a titanium foil approximately 0.1 millimeter (mm) thick, welded to two titanium electrodes 107 which maintain the shape of the heating chamber 101 and conduct current from the power controller as shown in FIG. 1. The volume of the heating chamber 101 can be approximately 1 milliliter (ml) in some embodiments. In some embodiments, the heating chamber can be formed with a deep drawn stamping technique wherein the side walls are also made from thin material. Any resistive material could be used for construction of the heating chamber, but due to their corrosion resistance, biocompatibility and detectable resistance change with changes in temperature, titanium and stainless steel are particularly well suited.

By removing most of the thermal mass with this novel construction, the amount of energy required from the battery to reach operating temperature is reduced proportionally. This leads to a smaller battery and a more portable device. A difficulty with this construction is that the electrical resistance resulting from usefully sized and durable geometry of this type is necessarily very low. In the preferred embodiment presented, the total electrical resistance of the atomizer is 0.01 ohms. This requires custom-made electronics to power and control.

The media loaded into this type of personal vaporizer is often a solid, wax or semi-solid. To undergo atomization via boiling and recondensation, it has to be subjected to two phase changes. The first phase change is from solid to liquid. The second phase change is from liquid to vapor. The vapor is then entrained in an airstream before being recondensed into an aerosol to be inhaled by the user. The thermal conductivity of a typical aerosolized solid material is low.

The rapid heating rate that the novel atomizer heater described here enables comes with a new difficulty. It is possible the portion of the material in contact with the heated wall of the chamber will vaporize before the portion away from the heated wall melts, because the heating of the chamber wall happens faster than the thermal conductivity of the material can transfer enough energy to the far portion to melt it. This is problematic, because it can launch chunks or globs of material into the airstream, which clogs the aerosol path and is unpleasant for the user

This is not an issue with existing personal vaporizer designs, because these systems can only raise their chamber temperatures slowly, because of the thermal mass of the separate heater and chamber walls. This maximum temperature rise rate with existing designs is slow enough to melt the material fully only some seconds or minutes later are able to reach a temperature sufficient to atomize the material.

The obvious solution is to apply less power in order to cause the temperature of the chamber wall to climb more slowly. Unbounded by the practical problem of the thermal mass of a chamber with separate structure and heating elements, a power level supplied by the controller to the heating chamber could be found such that the chamber reaches the boiling point of the material at the same time that all material is in a liquid state. However, there is a better way.

A new, better solution to this problem is a multi-stage controller, which has a melt mode and an aerosolization mode. The melt mode can be configured to heat the chamber to a temperature above the melting point of the material to be atomized, but below the boiling point of the material to be vaporized. Holding the chamber temperature in this range allows all of the material to melt but does not permit aerosolization.

The simplest model for heat transfer is Q=k*A*ΔT*t, which is useful for illustrating why this multi-stage controller is superior, even ignoring the surface area of the pellet for now. Q is fixed, because Q is the energy required to melt all the material, which if we neglect conduction and convection losses as minimal, is the same for all heating processes. Beginning at the point melting of any of the material starts, we can approximate that the temperature of the material as fixed at the melting point during the melting process. Thus, ΔT becomes T_{chamber}−T_{melting}. k is the heat transfer coefficient, which is fixed for a particular material.

The limiting cases for the melt temperatures chosen for a multi-stage controller would be infinitesimally above the melting temperature of the media at minimum, and infinitesimally below the boiling point of the media at maximum.

So, comparing an existing device which is power limited and increases temperature in a linear fashion to a temperature setpoint with the novel atomizer and controller which has separate melt and atomization stages for the same media properties and quantity, and the same chamber geometry, we get

k*A*ΔT*t_{legacy}=Q=k*A*Δ*tₙₒᵥₑₗ
k and A cancel, so the equation becomes

ΔT*t_{legacy}=ΔT*tₙₒᵥₑₗ
Where ΔT is T_{chamber}−T_{melting}

In the novel case, T_{chamber}−T_{melting} is fixed during the melting period, because T_{chamber} is controlled by the controller to a steady pre-programmed or user-selected temperature.

In the legacy case, T_{chamber}−T_{melting} is a linear ramp of time T_{melting}.

ΔT*t is equivalent of the integral of ΔT from zero to T_{melting}, integrating yields the following equation

Tₙₒᵥₑₗ=t_{legacy}/2

Therefore, in the best-case scenario where T_{melting} is chosen at exactly below the boiling point of the material, a two-stage controller can bring the material to a melted and ready to use state twice as fast as a legacy controller which ramps to the boiling temperature in a linear fashion.

In practical use, the boiling point of materials varies somewhat, and the temperature uniformity of the chamber is not perfect. However, it is plain that with a two-stage controller, any choice of melting temperature setpoint greater than halfway between the melting point and the boiling point of the material will cause the material to be in a fully melted, ready to use state faster than a controller that utilizes a linear ramp can, which is practical to do and yields meaningful time savings in the heating process. Because this is the time between when the user asked for aerosol and the time when the device begins to supply it, any savings here is valuable.

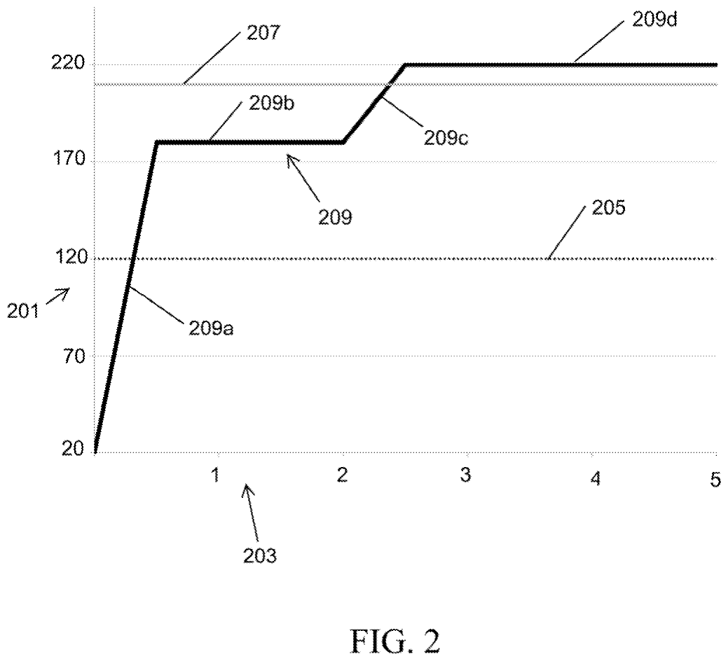

An example of the targeted chamber temperature for a two-stage controller is shown in FIG. 2. The vertical or Y-axis 201 represents the temperature in degrees Celsius and the horizontal or X-axis 203 represents the time in seconds. In the illustrative example, controller was configured with the first temperature setpoint at 180° C. and the second temperature setpoint at 220° C. where the melting point of the material is represented by the dotted line 205 was 120° C. and the boiling point of the material is represented by the horizontal line 207 was about 210° C. As can be seen, once activated, the heating chamber 101 took about 0.5 seconds to reach the first setpoint of 180° C. as indicated by segment 209a of the heating chamber heating cycle 209. The temperature of the heating chamber 101 was then maintained at the first temperature setpoint for approximately 1.5 seconds while the material within the chamber melted as indicated by segment 209b of the heating chamber heating cycle 209. Then, as indicated by segment 209c of the heating cycle, the controller increased the temperature of the heating chamber 101 to the second setpoint over a period of about 0.5 seconds. The melted material is then vaporized over the segment 209d of the heating cycle as the temperature of the material is raised above the boiling point of the material as shown in FIG. 2.

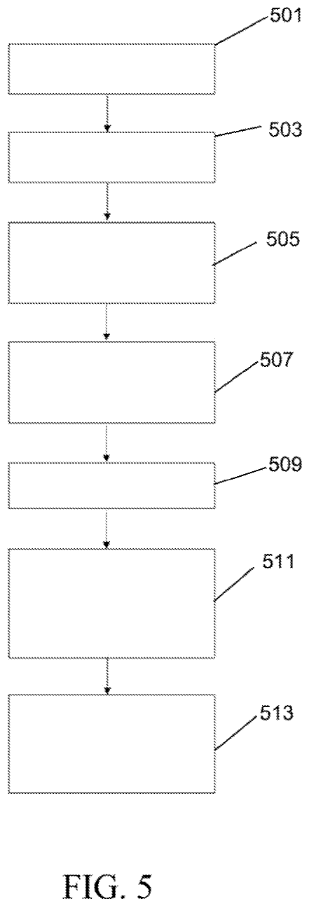

A flow-chart of the heating sequence is shown in FIG. 5. As shown, The heating sequence can begin with the user requesting aerosol by activating the device as indicated by 501 in FIG. 5. In response to the user request, the heating sequence can proceed to step 503 wherein the controller can then operate the heating sequence to heat the heating chamber to a first set temperature that is the melting temperature or a temperature between the melting temperature and the boiling point of the material in the heating chamber. The heating sequence can then proceed to step 505 where the controller applies energy to the heating chamber to raise the heating chamber to the first set temperature. The heating sequence can then proceed to step 507 where the controller stops increasing the temperature of the heating chamber and holds the temperature of the heating chamber at the first set temperature for a predetermined period of melting time. After the predetermined period of melting time has passed, the controller changes the set point to the second temperature setpoint at step 509. The heating sequence then proceeds to step 511 wherein the controller again applies energy to increase the heating chamber from the first set temperature to a second setpoint temperature where the material is aerosolized. As indicated at step 513, the controller then continues to apply energy to maintain the heating chamber at the second set temperature until the user no longer requests aerosol.

In both cases of FIGS. 2 and 5 discussed above, the maximum heating rate is a function of the area of contact between the chamber wall and the material. The problem of melting is especially acute with solid materials which are loaded in a chunk or pellet form, with minimal surface contact with the walls initially upon loading. Because the heat transfer from the chamber wall to the material is via conduction, less contact area will lead to less heat transfer into the pellet of material for a given chamber wall temperature. Again, with legacy systems that require tens of seconds to minutes to heat, this is not an issue, but with the novel atomizer construction described here it represents a loss of potential performance.

Another novel solution to this problem is afforded by the controller containing multiple temperature setpoints. A pre-melting operation can be performed. The chamber must be opened for the user to load new material from time to time. After the material is loaded is an ideal time to melt the material load from a pellet or irregular shape to a thin film that conforms to the chamber walls. By pre-melting the material to the chamber walls, the area of contact between the material and chamber walls is increased at a time when the user has not requested aerosol. This increase in area during all active requests for aerosol decreases the time it takes to return the material from a solid to a liquid, further improving performance.

A sensor or switch can be configured to detect the opening of the chamber for loading media. When the chamber is opened as sensed by the sensor, the controller can automatically increase the chamber temperature to melt the material. The goal is to melt the material but not aerosolize it with the chamber open, because the user cannot inhale in this state and, since the aerosol has not yet formed, the aerosol is prevented from escaping through the chamber opening, thereby preventing loss of material. For these reasons, it is desirable to have a melting temperature setpoint for the heating chamber which is above the melting point of the media and below the boiling point of the media. This setpoint is programmed into the controller's memory and automatically selected by the controller when the chamber opening sensor detects an open chamber condition. When the chamber is closed by the user, the controller's setpoint is returned to the aerosolization temperature.

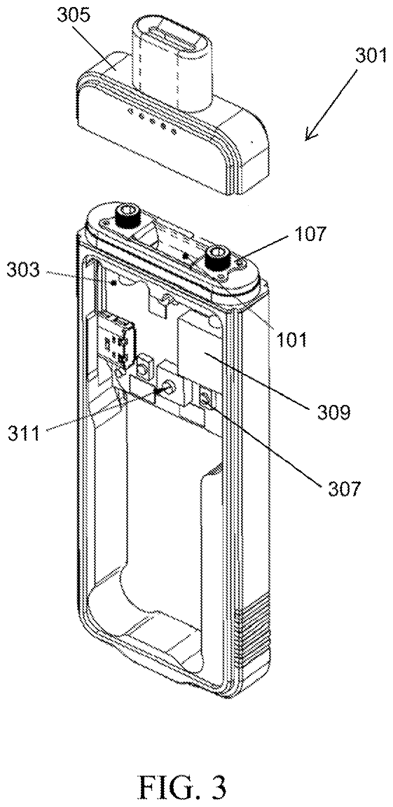

FIG. 3 illustrates a system 301 utilizing a sensor 303 that detect the chamber being in an open state. In some embodiments, the system can comprise a cap 305 that operates as the heating chamber closure wherein the cap can be snapped over the top of the heating chamber to close the heating chamber or removed to open the heating chamber to allow reloading of the heating chamber. In some embodiments, the sensor 303 can comprise a magnetic sensor that can detect when the cap is properly secured to sense of the system 301 is in an open state or a closed state. Because the chamber may be open without actively loading material, it may be preferable to only begin this pre-melting function on user instruction.

A Fire button 307 can be built into the controller 309, which is also used to command the generation of aerosol is used for this purpose in the preferred embodiment, but other means of activation, such as a separate button on wireless control from an application running on another computing device could also be used.

In some cases, it may be preferable to continue the melting process for some period of time after the chamber is closed, to ensure complete melting. In this case, the controller 309 would cause the heating chamber 101 to remain at the melting temperature for some preset time period after the sensor 303 detects the chamber is in the closed state. This could be triggered by the closing of the heating chamber 101 as detected by the sensor 303, or by the termination of a user command for the melt mode.

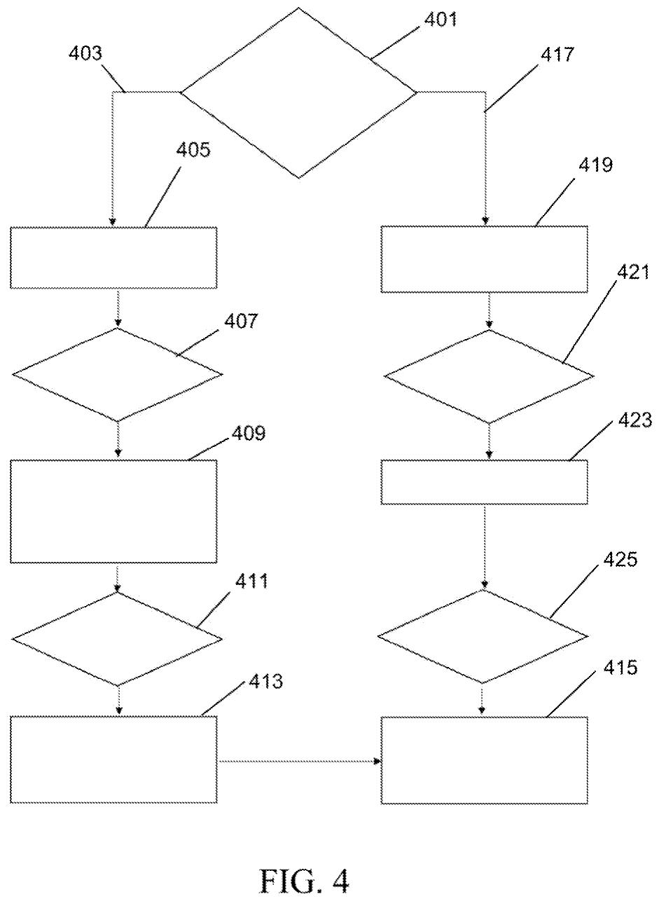

In the manually commanded melting case, the chamber opening sensor 303 is used to select the melting setpoint. If, with the heating chamber open, the user presses a button, the heater is driven to the melting temperature until the user releases the button. When the switch or sensor 303 detects that the user has closed the heating chamber 101 again, the controller setpoint is returned to the aerosolization temperature. This function is shown in FIG. 4. For example, referring to FIG. 4, the sensor 303 can determine at step 401 if the heating chamber 101 is in an open or closed state. If in an open state, as indicated by arrow 403, the method can proceed to step 405 where the controller sets the temperature of the heating chamber 101 to the melting temperature of the material. If the user then presses the fire button 307 while the sensor 303 senses the heating chamber 101 is in the open state, as indicated by step 407, the method may then proceed to step 409 where the controller applies power to increase the temperature of the melting chamber to the melting setpoint and maintain the temperature at the melting setpoint. After the user releases the fire button 307 at step 411, the method then proceeds to step 413 where the controller optionally maintains the temperature at the melting setpoint for an additional time period before proceeding to step 415 where the controller stops applying power to the heating chamber 101, allowing the heating chamber 101 to cool. Referring back to step 401, if the sensor 303 determines that the heating chamber 101 is in a closed state, as indicated by arrow 417, the method proceeds to step 419 wherein the controller sets the temperature setpoint to the aerosolizing temperature. If the user then presses the fire button 307 while the sensor 303 senses the heating chamber 101 is in the closed state, as indicated by step 421, the method may then proceed to step 423 where the controller generates an aerosol by way of a predetermined sequence. After the user releases the fire button 307 at step 425, the method then proceeds to step 415 where the controller stops applying power to the heating chamber 101, allowing the heating chamber 101 to cool.

An alternative embodiment would place the heating chamber 101 into melt mode at the melting temperature setpoint for a period of time after the opening sensor 303 detects the heating chamber 101 has been closed after opening by the user, on the presumption that the user has completed the loading of material. This would prevent the user from being exposed to elevated temperatures. A further optional improvement to this system would incorporate an orientation-sensing element, such as an accelerometer or tilt switch, connected to the controller, to only allow the melting mode when the device is in an orientation that will not allow spills, leakage or contamination.

A lower cost alternative embodiment of the system described above would utilize a controller that varies the voltage, current or power supplied to the atomizer, rather than directly controlling the heater temperature. An even-lower cost alternative embodiment would utilize PWM of the output from the controller to the atomizer to set an average power, voltage or current supplied to the heater. In all cases, having a plurality of setpoints to melt the material loaded, and then aerosolize the material at a different output setting is preserved.

Additional setpoints could be added as an extension of the controller. For example, a third setpoint might be used for a cleaning temperature. The chamber opening switch could be used to interlock the cleaning mode to only be available when the chamber is open.

The temperature for melting during the atomization sequence and the temperature for pre-melting during loading are not necessarily the same. For example, the optimal temperature for melting during the atomization sequence could be higher than the optimal temperature for pre-melting due to user safety concerns.

The setpoint for one or more of the controller output modes can be made user adjustable. This is desirable because different materials are optimally melted at different temperatures, and optimally aerosolized at different temperatures. This could be accomplished with on-device controls, as shown by the user interface in FIG. 3, or via other means, such as Bluetooth, voice control, or an accessory computer program.

What is claimed is:

1. A personal vaporizer comprising:
a battery;
an electrical controller; and
a chamber for material to be atomized,
wherein material of a wall of the chamber serves as both a resistance heater and a structural element to contain the material to be atomized.

2. The vaporizer of claim 1, wherein the wall that serves as both the resistance heater and structural element comprises a metal foil.

3. The vaporizer of claim 2, wherein the metal foil comprises titanium.

4. The vaporizer of claim 2, wherein the metal foil comprises stainless steel.

5. The vaporizer of claim 1, wherein the chamber is configured heat the material to generate aerosol in less than 5 second from being activated.

6. The vaporizer of claim 5, wherein the controller is configured to respond to the chamber being activated by increasing the chamber temperature to a first temperature setpoint above a melting temperature of the material to be atomized, then after a time delay, automatically increasing the chamber temperature to a second temperature setpoint above the boiling temperature of the material to be atomized.

7. The vaporizer of claim 6, wherein one or more of the first temperature setpoint, the second temperature setpoint, or the time delay are user-adjustable.

8. A personal vaporizer comprising:
a battery;
an electrical controller;
a chamber for the material to be atomized to be reloaded with material;
a user-openable entrance to the chamber; and
a sensor configured to detect a status of whether the user-openable entrance is in an open orientation or a closed orientation and transmit the detected status to the electrical controller.

9. The vaporizer of claim 8, wherein the electrical controller is configured to control a temperature of a heating portion integral to the chamber.

10. The vaporizer of claim 9, wherein the controller has at least two temperature setpoints, which are automatically selected between according to a state of the chamber as sensed by the sensor.

11. The vaporizer of claim 10, wherein at least one of the plurality of setpoints is user-adjustable.

12. The vaporizer of claim 9, wherein the electrical controller is configured to control the temperature, power, average voltage or average current supplied to the heating portion integral to the chamber.

13. The vaporizer of claim 12, wherein the controller has at least two setpoints, which are automatically selected according to the state of the chamber as sensed by the sensor.

14. The vaporizer of claim 13, wherein at least one of the plurality of setpoints is user-adjustable.

15. An electrical controller for a personal vaporizer comprising:
a converter stage configured to supply a variable amount of power to a heating chamber;
a temperature sensor configured to detect the temperature of the heating chamber;
a chamber sensor configured to sense an open state or a closed state of the heating chamber; and
two or more temperature setpoints for the temperature of the heating chamber, which are configured to be automatically selected between depending on the open or closed state of the heating chamber as sensed by the chamber sensor.

16. The electrical controller of claim 15, further comprising a voltage sensing element and a current sensing element, and wherein the electrical controller is configured to calculate the temperature of the heating chamber by the change in electrical resistance of the heating chamber.

17. The electrical controller of claim 15, wherein one or more of the temperature setpoints are user-adjustable.
